(19) United States
(12) Patent Application Publication
(10) Pub. No.: US 2006/0194892 A1
(43) Pub. Date: Aug. 31, 2006

(54) Blended foam having improved flexibility at sub-freezing temperatures

(75) Inventors: Natarajan S. Ramesh, Grapevine, TX (US); Matt Jones, St. Charles, MO (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 11/068,317

(22) Filed: Feb. 28, 2005

(51) Int. Cl. C08J 9/00; C08L 23/04

(52) U.S. Cl. 521/134; 525/240; 521/142

(57) ABSTRACT

The invention is a foam blend comprising a polyethylene, polypropylene, and a rubber component. The foam blend has improved flexibility at sub-zero temperatures without sacrificing the desirable physical characteristics that are commonly associated with polypropylene foams. As a result, the foam is particularly useful for producing articles that require flexibility at temperatures approaching and below 0° F. In some embodiments, the foam blend may have at least 50 percent by weight polypropylene and up to about 45 percent by weight polyethylene. The rubber component in the blend may be from about 3 to 10 weight percent, with 5 weight percent being particularly useful. The foam blends are suitable for producing a variety of articles where it is desirable to have improved flexibility at cold temperatures. In a particularly useful application, the foam blend may be used in concrete expansion joint fillers or totes.

### BACKGROUND OF THE INVENTION

The invention relates generally to polyolefin foams and more particularly to foamed articles comprising a blend of polypropylene and low density polyethylene.

Polyolefin foams such as polyethylene are used to produce foam sheets from which a variety of articles can be created. One application includes the production of foamed expansion joint fillers that can be used in repairing cracks in an existing concrete surface or in creating a new concrete surface. In new concrete construction, the expansion joint filler is typically used to divide the concrete surface into discreet regions. The resiliency of the foam joint allows it to expand and contract with the concrete. The flexibility of the foam also allows the expansion joint filler to be used to fix an existing crack. Typically, most cracks are non-linear and may have several sharp turns or bends. The flexible foam joint can be positioned within the crack so that it follows the contour of the crack. Concrete filler may then be added on opposing sides of the foam to complete the repair.

Polyethylene (PE) is one of the most widely used polyolefin foams. While polyethylene possesses a number of beneficial physical and chemical properties when used to produce a foamed sheet, a disadvantage of PE is that extruded foam sheets made therefrom have a flexural modulus that is lower than would otherwise be desired for certain applications, such as expansion joint fillers. Additionally, polyethylene foam typically has lower temperature resistance than desired for certain applications requiring exposure to relatively high temperatures, such as construction applications where hot sealant may be used in combination with an expansion joint filler.

Polypropylene (PP) is one possible alternative to polyethylene. PP foams are typically stiffer and have greater temperature resistance than PE foam. However, molten PP generally has poor melt strength, which may make it difficult to produce acceptable quality foam, i.e., one having a uniform array of fully-formed, closed cells. Further, PP foams are often brittle and allow cracks to propagate readily through the foam. In addition, PP foams generally exhibit poor thermoformability such that it is difficult to thermoform such foams into desired shapes.

### BRIEF SUMMARY OF THE INVENTION

The invention is a composition comprising a blend of polyethylene, polypropylene, and a rubber component having specific advantages for sub-freezing applications. The composition includes a foam blend has improved flexibility at sub-freezing temperatures without sacrificing the desirable physical characteristics that are commonly associated with polypropylene foams. As a result, the foam is particularly useful for producing articles that require flexibility at sub-freezing temperatures.

In some embodiments, the foam blend may comprise at least 50 percent by weight polypropylene and up to about 45 percent by weight polyethylene. The rubber component in the blend may be from about 3 to 10 weight percent, with 5 weight percent being particularly useful. A particularly useful rubber component includes di-block and tri-block styrene-elastomer block copolymers. A preferred styrene-elastomer block copolymer comprises a tri-block copolymer structure which includes styrene end-blocks and a mid-block of a saturated olefin elastomer.

The foam blends may be suitable for producing a variety of articles where it is desirable to have improved flexibility at cold temperatures. In a particularly useful application, the foam blend may be used in concrete expansion joint fillers or totes.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a graphical cross-sectional view of a foam sheet comprising the foam blend of the invention;

FIG. 2 is a graphical illustration of the foam sheet of FIG. 1 in the form of an expansion joint filler;

FIG. 3 is a graphical illustration depicting one possible use of the expansion joint filler of FIG. 2;

FIG. 4 is a graphical illustration of a concrete form comprising the foam blend of the invention being used to create a concrete surface;

FIGS. 5A through 5E are graphical illustrations depicting a method of using the expansion joint filler to repair a crack in a concrete surface; and

FIGS. 6A through 6C are graphical illustrations depicting a tote comprising the foam blend of the invention.

### DETAILED DESCRIPTION OF THE INVENTION

The present invention now will be described more fully hereinafter with reference to the accompanying drawings, in which some, but not all embodiments of the invention is shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

The foam blend of the invention may comprise polypropylene that is blended with polyethylene and a rubber component that is present in the blend in the range from about 3 to 10 weight percent. The presence of the rubber component helps to improve the flexibility of the polypropylene foam without sacrificing the desired stiffness of the foam.

Suitable polypropylenes for use in the blend may include atactic, isotactic, syndiotactic, linear and long-chain branched PP homopolymers and copolymers, such as propylene/ethylene copolymer, and combinations thereof. Useful polypropylene homopolymers may have a melt flow index ranging from about 1 to 20 and a density ranging from about 0.87 to 0.915 g/cc. Further, a high melt strength/long-chain branched polypropylene is particularly useful. Such polypropylenes exhibit higher extensional viscosity when compared to other polypropylenes, resulting in beneficial strain hardening when the cells are expanded during the foaming process. A particularly useful polypropylene includes PP homopolymers and copolymers having a melt tension of greater than about 20 centinewtons at 200° C. (“high melt tension PP” or “HMT-PP”). Such HMT-PPs preferably have a melt flow index ranging from about 1 to 20 and a density ranging from about 0.88 to 0.910 g/cc. In some embodiments, the polypropylene may comprises a blend of high melt tension and low melt tension polypropylene. Low melt tension polypropylene refers to polypropylenes having a melt tension of about 20 centinewtons at 200° C. or less, including polypropylenes having a melt tension of less than about 10 centinewtons at 200° C. In some embodiments, the polypropylene in the foam blend may include at least about 40 percent high melt tension polypropylene, based on the total weight of the blend.

A suitable blend of HMT-PP and low density polyethylene is described in U.S. Pat. No. 6,462,101 to Ramesh et al., the contents of which are hereby incorporated by reference. In some embodiments, the foam blend may comprise about 60 percent by weight high melt polypropylene having a high melt tension of greater than about 20 centinewtons at 200° C., about 20 percent by weight low melt polypropylene having a low melt tension of less than about 20 centinewtons at 200° C., about 15 percent by weight ethylene vinyl acetate, and about 5 percent by weight rubber component.

In accordance with the present invention, “melt tension” may be determined by stretching a strand of polymer between two counter-rotating wheels and maintaining the temperature of the polymer at 200° C. The frequency of rotation increases linearly and the resultant pulling force increases as the filament is stretched. The force is recorded in centinewtons (cN) until the polymer strand breaks. The maximum force obtained before break is recorded as the melt tension of the polymer. The foregoing procedure may be performed as described by M. B. Bradley and E. M. Phillips in the Society of Plastics Engineers's ANTEC 1990 Conference paper at page 718, the disclosure of which is hereby incorporated herein by reference. A suitable device for performing the test is a Rheotens Melt tester.

The foam blend may include polyethylene homopolymers or copolymers. Examples of useful polyethylene homopolymers include low density polyethylene and high density polyethylene. Polyethylene copolymers may include, e.g., ethylene vinylacetate copolymers, homogeneous ethylene/alpha-olefin copolymers (i.e., metallocene/single-site catalyzed copolymers of ethylene and, e.g., one or more C₃ to C₁₀ alpha-olefin comonomers) or heterogeneous (i.e., Ziegler-Natta catalyzed) ethylene/alpha-olefin copolymers. A preferred polyethylene is low density polyethylene (LDPE) having a melt flow index ranging from about 1 to about 40 and a density ranging from about 0.912 to about 0.930 g/cc.

A suitable rubber component may include thermoplastic elastomers comprising a copolymer or terpolymer including a styrenic component and a rubbery component, with the rubbery component having at least one carbon-carbon double bond and comprising at least about 70 wt. % of the thermoplastic elastomer. A preferred thermoplastic elastomer comprises a block copolymer or terpolymer, wherein the rubbery component is distributed in the copolymer or terpolymer between styrenic end-blocks. Preferred examples of such block copolymers or terpolymers that are useful in accordance with the present invention include the following: styrene-ethylene-butylene-styrene block copolymer (SEBS), styrene-butadiene-styrene block copolymer (SBS), and styrene-isoprene-styrene block copolymer (SIS). As an alternative to block copolymers and terpolymers, random copolymers and terpolymers comprising styrene and a rubbery component may be employed, such as polybutadiene/styrene rubber.

It may be possible to employ other rubber components in the foam blend, such as, e.g., polybutadiene rubber, butyl rubber, polychloroprene rubber, acrylonitrile-butadiene rubber, vinylpyridine rubber, ethylene-propylene rubber, etc., provided that such rubber components can be processed into the foam blend. Thermoplastic elastomers comprising a styrenic component and a rubbery component as described above have been found optimally suited to achieve the foregoing objectives in accordance with the present invention.

A particularly useful rubber component includes di-block and tri-block styrene-elastomer block copolymers. A preferred styrene-elastomer block copolymer comprises a tri-block copolymer structure which includes styrene end-blocks and a mid-block of a saturated olefin elastomer. Typically, in these tri-block copolymer structures, the saturated olefin elastomer mid-block may comprise butadiene, isoprene, ethylene-butylene, or ethylene-propylene.

Particularly preferred for the present invention is a styrene-isoprene-styrene (SIS) block polymer having greater than 80 wt. % isoprene (i.e., the rubbery component), and most desirably a SIS block copolymer which is predominately a linear tri-block copolymer structure. A useful rubber component includes SIS block copolymer having a styrene to rubber (elastomer) ratio of from 30 to 70 with an Average Molecular Weight (Mₙ) in the range of 50,000 to 300,000, most desirably about 200,000.

The amount of rubber component in the blend may be in the range from about 3 to 10 weight percent, based on the total weight of the blend. It has been discovered that the foam blends comprising at least 3 weight percent rubber component have improved flexibility and reduced brittleness at sub-freezing temperatures. In particular, foam blends having a rubber component of at least 4 weight percent showed improved flexibility at sub-freezing temperatures. Typically, the amount of rubber component in the blend should be sufficient to prevent the foam from breaking at sub-freezing temperatures, and more typically at temperatures approaching −20° F. Foam blends having a rubber component that exceeds 10 weight percent may have increased softness that is less than desirable for expansion joint filler applications and other articles. However, it should be recognized that in some embodiments the foam blend may include a rubber component in excess of 10 percent, although not necessarily with equivalent results.

The amount of polypropylene in the blend is typically at least about 50 weight percent, based on the total weight of the blend, with a weight percentage of about 70 to 90 being somewhat more typical. Polyethylene may be present in the blend with polypropylene at a weight percentage ranging from about 1 to about 45, based on the total weight of the blend. More typically, the weight percentage of PE in the blend ranges from about 5 to about 25, such as from about 10 to about 20. In a particularly useful embodiment, the foam blend comprises about 80 percent by weight polypropylene, about 15 percent by weight low density polyethylene, and about 5 percent by weight rubber component.

The density of the foam in some embodiments may range from about 0.5 to about 15 pounds/ft³. Somewhat more typically, the density ranges from about 1.5 to about 10 pounds/ft³. The foam may be in the form of a sheet or plank having a thickness ranging from about 0.025 to about 4 inches and, more typically, from about 0.06 to about 3 inches.

In some embodiments, the foam blend may comprise a blend of polypropylene and ethylene vinylacetate. It has been discovered by the Applicants, that the flexibility of polypropylene foams can be improved by preparing a blend of polypropylene and ethylene vinylacetate. The amount of ethylene vinylacetate in the blend may range from about 5 to 25 percent by weight, with a range from about 10 to 20 weight percent being somewhat more typical. In some embodiments, the flexibility may also be improved by preparing a blend comprising polypropylene, ethylene vinylacetate, and the rubber component. In another useful embodiment, the foam blend may comprise about bout 80 percent by weight polypropylene, about 15 percent by weight ethylene vinyl acetate, and about 5 percent by weight rubber component.

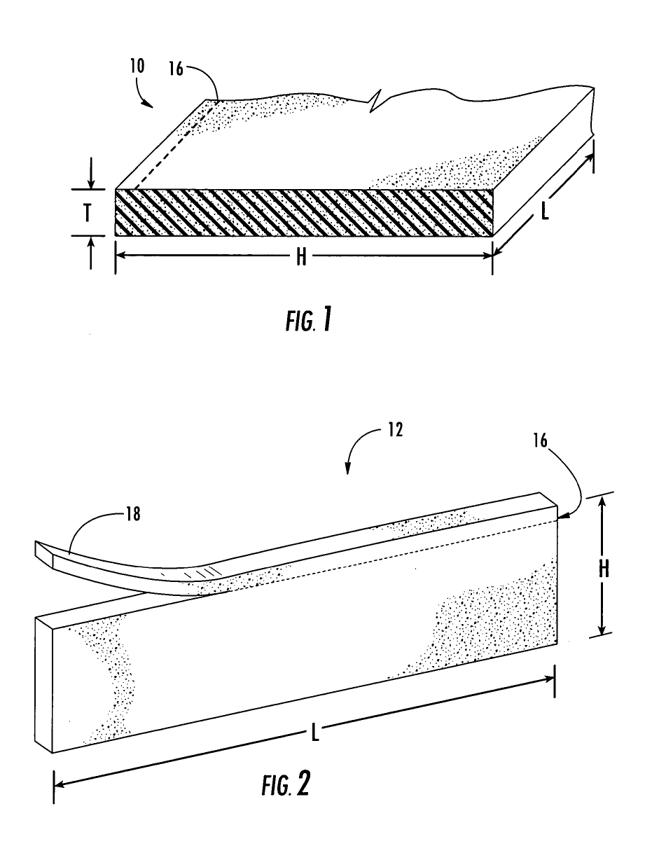

The foam blend of the invention is particularly useful for producing foam sheets and articles. In some embodiments, the foam blend is ideally suited as a concrete forming material. In this regard, FIG. 1 illustrates a cross-section of a concrete forming material, which is broadly designated as reference number 10. Typically, the concrete forming material has a thickness T ranging from about ¼ to 4 inch thick and a height H that is typically greater than about 2 inches. The height of the concrete forming material will typically depend upon the dimensions of the concrete structure that is to be formed. In some embodiments, the concrete forming material may also include one or more score lines 16 that extend across a surface of the foam. The score lines are typically a pre-cut area that extends partially through the thickness of the foam sheet. The score lines allow a user to quickly separate a portion of the foam so that the concrete forming material can be configured to have a desired height.

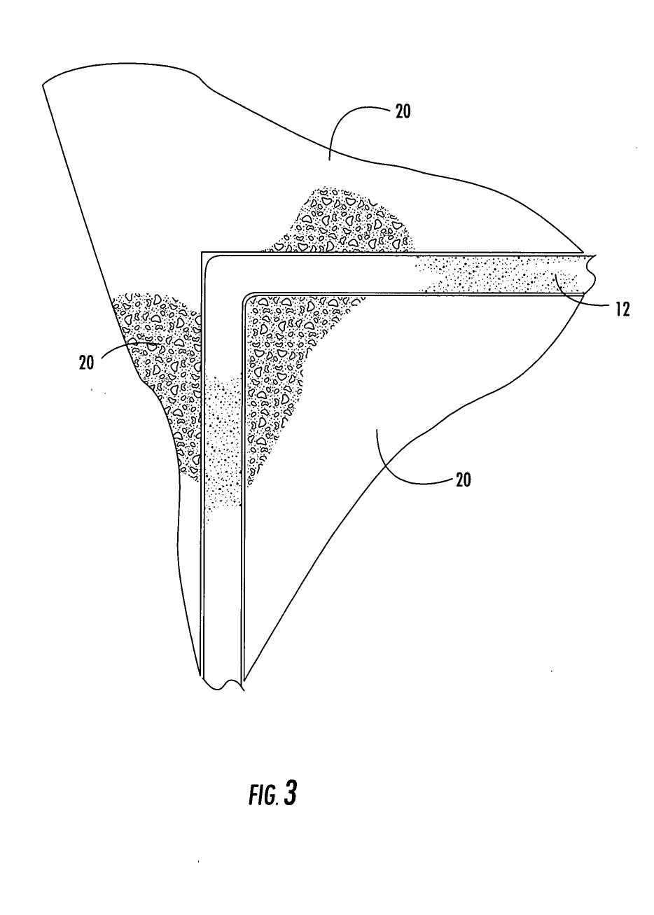

With reference to FIG. 2, the concrete forming material of FIG. 1 is depicted in the form of a foam expansion joint filler 12. The expansion joint filler may be ideally suited for preparing concrete sections or part of a process of repairing cracks in preexisting concrete surfaces. Expansion joint filler 12 comprises a foam sheet having a length “L” and a height “H.” In some embodiments, the expansion joint filler 12 may include one or more score lines 16 that can be used to detach a portion 18 of the expansion joint filler 12. The score line allows the height of the expansion joint filler to be selectively adjusted at the point of use. As a result, the expansion joint filler can be adapted to a wide variety of different applications. The score line typically comprises a line of weakening that is formed in the foam sheet and extends longitudinally along the length of the expansion joint filler. In some embodiments, the score line can be created by cutting a recess into the foam that extends partially through the width of the foam sheet. In other embodiments, the score line may comprise an intermittent line of weakening having a plurality of spaced recesses or slits that may extend through the full width of the foam sheet. The amount of foam that may be removed by tearing across the score line typically ranges from about ¼ to 1 inch in height with a height of ½ inch being somewhat more typical. When the expansion joint filler is used in combination with a sealant, the score lines or tear-off strip may allow a user to remove a predetermined amount of the foam. This allows a quick and correct amount of open space to fill with sealant after the concrete has cured.

With reference to FIG. 3, an expansion joint filler 12 is illustrated in the process of being used to create a new concrete surface. Here, the expansion joint filler is positioned between two separated concrete surfaces 20. The flexibility of the expansion joint filler allows it to easily conform to a configuration that can be used to create an expansion joint between the concrete slabs 20.

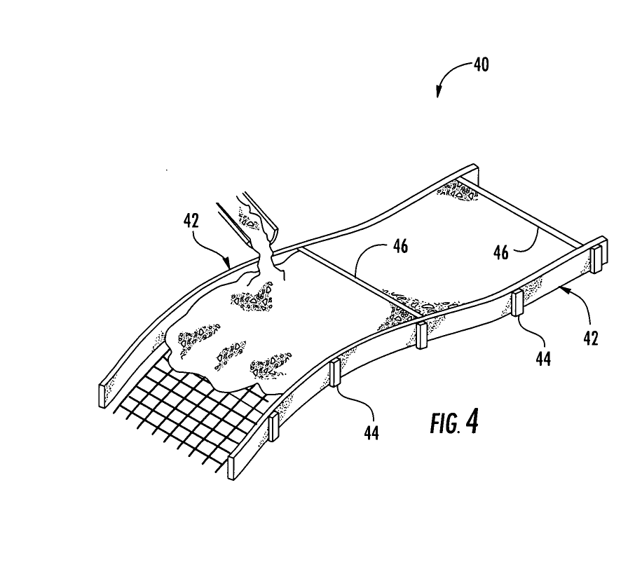

Referring to FIG. 4, there is shown a concrete structure 40 which is constructed utilizing concrete forms 42 and expansion joint fillers 46 manufactured from the foam blend of the invention. Forms 42 have sufficient flexibility to adapt readily to the construction of concrete structures which are curvilinear in shape. Alternatively, the forms 42 may be utilized to construct a concrete structure having sides which are straight and parallel. In either event, the concrete forms 42 can be retained in place by retaining members 44 formed from wood, plastic, metal, or the like which are driven into the underlying surface in a conventional manner.

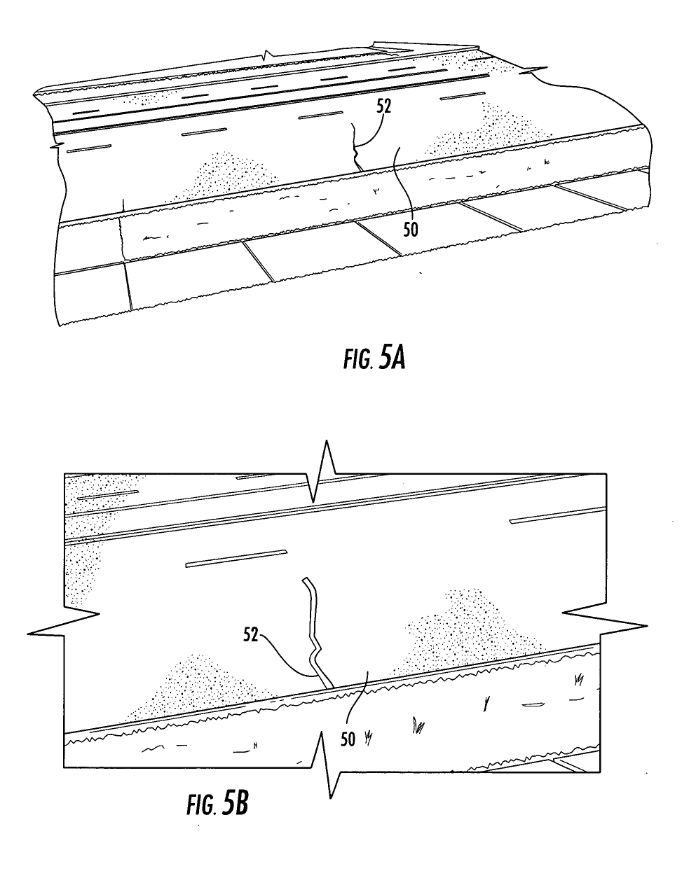

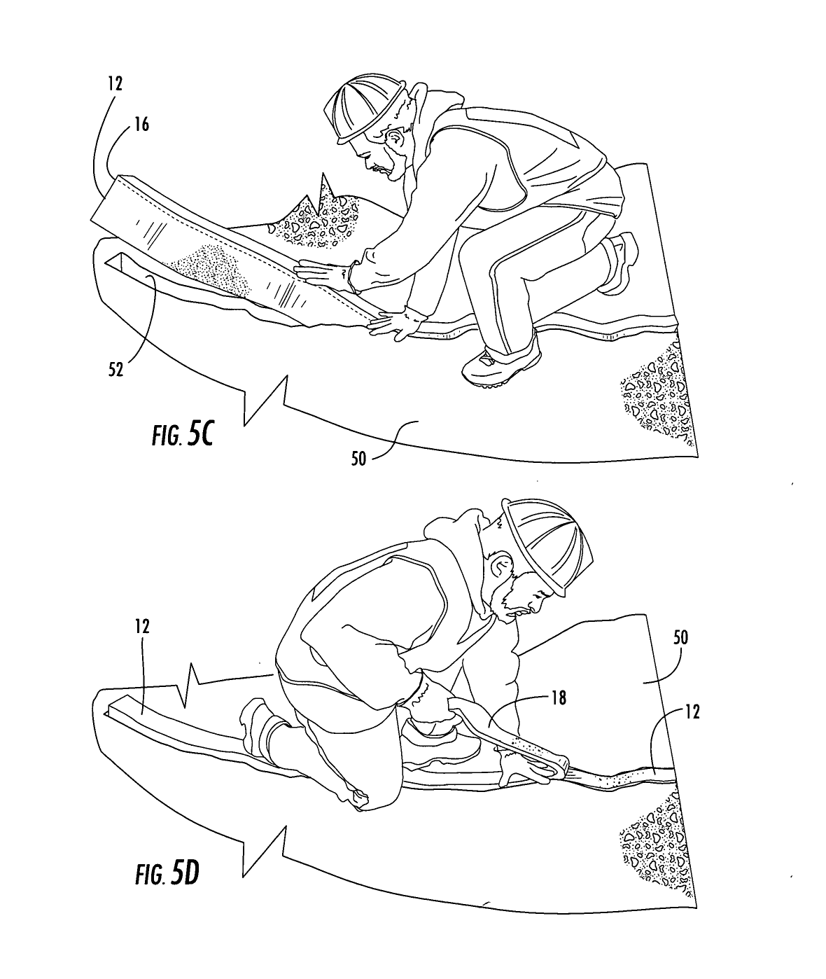

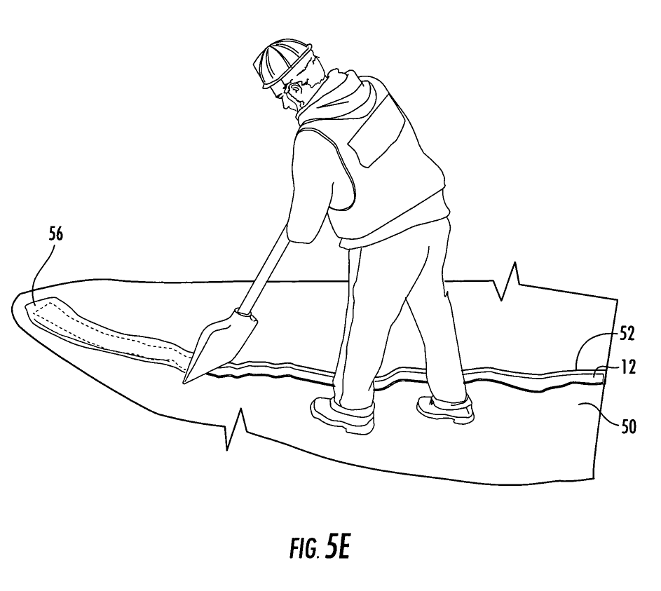

With reference to FIGS. 5A through 5E, the process of using an expansion joint filler to repair a crack in an existing concrete is illustrated. In FIG. 5A, a crack 52 is depicted in a concrete surface 50. In the FIG. 5B, the crack has been milled with a half circle format approximately 4″ in depth at the point of the crack and sawcut to have a consistent width of the crack 52 to help facilitate inserting an expansion joint filler into the crack. In some embodiments, a portion of the concrete surrounding the crack may be milled out to create a trough in which the expansion joint filler may be disposed. In FIG. 5C a worker is shown inserting the lower portion of the expansion joint filler just enough to “plug” the crack. The flexibility of the expansion joint filler 12 helps the worker to more easily manipulate the expansion joint to fit the contours of the crack 52. The concrete is then poured on both sides of the expansion joint filler to a point where it is level with the top of the expansion joint filler. It is then allowed to cure. In the illustrated embodiment, the expansion joint filler may include one or more score line 16. Score line 16 allows a worker to remove excess foam and apply the sealant after curing. In this regard, FIG. 5D depicts a worker removing a portion 18 of the expansion joint filler filler to create an area to apply sealant on top of the remaining expansion joint filler 12. As shown in FIG. 5E, repair of the crack may be completed by applying sealant. If the user does not want to use sealant, they simply leave the entire foam expansion joint filler in the expansion joint. The flexibility of the expansion joint filler also helps the concrete to expand and contract without additional cracking.

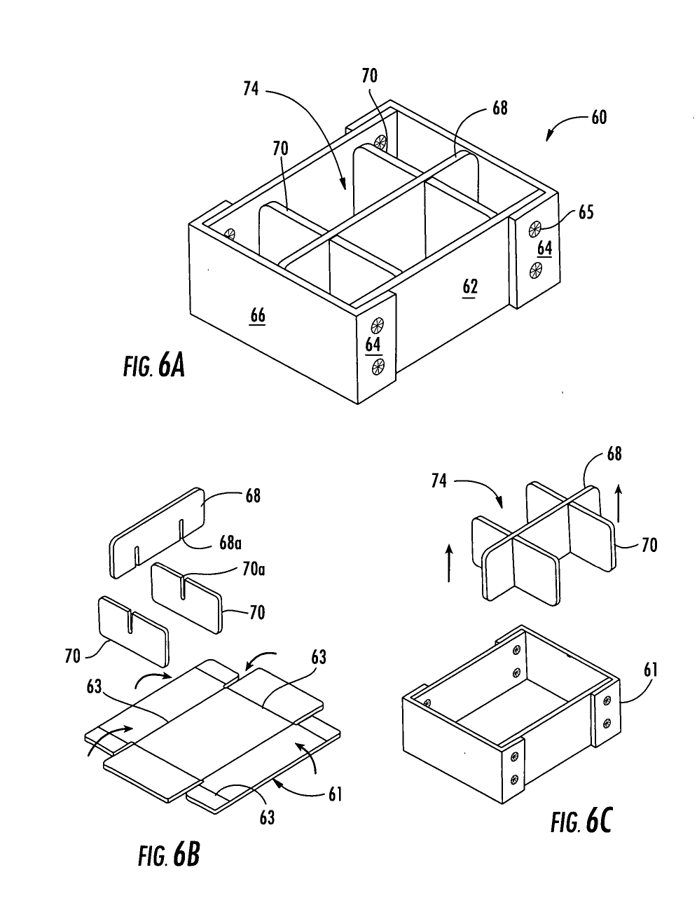

The foam blend is also particularly useful for producing foamed structures such as totes. In this regard, FIGS. 6A through 6C illustrate an exemplary tote 60 that comprises the foam blend of the invention. The assembled tote 60 is illustrated in FIG. 6A. In the illustrated embodiment, the tote 60 includes four walls 66, 62 that define the sidewalls of the tote. As shown in FIG. 6B, the tote may be assembled from a foam sheet 61 that has been pre-cut to define sidewalls 62 and 66. Typically, the foam sheet includes a plurality of score lines 63 that facilitate folding sidewalls upwardly to form the walls of the tote. Flaps 64 may then be folded over sidewall 62 and secured to the sidewall with a fastener 65, such as a grommet or screw. In some embodiments, the tote may also include one or more removable partitions 74 that are formed from one or more pre-cut sheets of foam 68, 70. The partitions can be created by sliding foam sheets 68, 70 together. In the illustrated embodiment, each sheet 68, 70 has a slot 68a, 70a, respectively, that is adapted to slidingly engage the corresponding slot 70a, 68a on the other foam sheet. As shown in FIG. 6C, the partition 74 may be removable from the interior space of the tote.

Totes prepared in accordance with the invention are particularly useful for the transportation and storage of a variety of parts, such as automotive and airplane parts. The resilience of the foam blend may help prolong the life of the tote. The resiliency of the foam blend also may help prevent fracture or breakage of the totes in cold weather applications.

In producing the foam sheets and articles described herein, any conventional chemical or physical blowing agents may be used. Preferably, the blowing agent is a physical blowing agent such as carbon dioxide, ethane, propane, n-butane, isobutane, pentane, hexane, butadiene, acetone, methylene chloride, any of the chlorofluorocarbons, hydrochlorofluorocarbons, or hydrofluorocarbons, as well as mixtures of the foregoing.

The blowing agent may be mixed with the polymer resin (i.e., the blend of PE, PP, and the rubber component) in any desired amount to achieve a desired degree of expansion in the resultant foam. Generally, the blowing agent may be added to the polymer resin in an amount ranging from about 0.5 to 80 parts by weight, based on 100 parts by weight of the polymer. More preferably, the blowing agent is present at an amount ranging from 1 to 30 and, most preferably, from 3 to 15 parts per 100 parts by weight of the polymer.

If desired or necessary, various additives may also be included with the polymer. For example, it may be desirable to include a nucleating agent (e.g., zinc oxide, zirconium oxide, silica, talc, etc.) and/or an aging modifier (e.g., a fatty acid ester, a fatty acid amide, a hydroxyl amide, etc.). Other additives that may be included if desired are pigments, colorants, fillers, antioxidants, flame retardants, stabilizers, fragrances, odor masking agents, and the like.

Foam in accordance with the present invention is preferably made by an extrusion process that is well known in the art. In such a process, the polymeric components are added to an extruder, preferably in the form of resin pellets. Any conventional type of extruder may be used, e.g., single screw, double screw, and/or tandem extruders. In the extruder, the resin pellets are melted and mixed. A blowing agent is preferably added to the melted polymer via one or more injection ports in the extruder. Any additives that are used may be added to the melted polymer in the extruder and/or may be added with the resin pellets. The extruder pushes the entire melt mixture (melted polymer, blowing agent, and any additives) through a die at the end of the extruder and into a region of reduced temperature and pressure (relative to the temperature and pressure within the extruder). Typically, the region of reduced temperature and pressure is the ambient atmosphere. The sudden reduction in pressure causes the blowing agent to nucleate and expand into a plurality of cells that solidify upon cooling of the polymer mass (due to the reduction in temperature), thereby trapping the blowing agent within the cells.

The foregoing, as well as other, aspects and advantages of the invention may be further understood by reference to the following examples, which are provided for illustrative purposes only and are not intended in any way to be limiting. In general, flexibility of the foam blends at sub-freezing temperatures were determined by chilling the foam blends at an appropriate temperature for at least 4 hour followed by bending the foam at least 90 degrees. Foams that did not break or fracture were considered acceptable.

### EXAMPLES

### Example 1

The foam blends in example 1 were prepared with a twin-screw extruder. The following ingredients were used.
polypropylene homopolymer Model No. PF814 available from Basell Polyolefins (about 0.9 g/cc and 3 Melt Index (MI));
2.3 MI, 0.919 g/cc LDPE available from Nova;
styrene-isoprene-styrene rubber component grade Model No. Europrene Sol T 190 available from Enichem; and
Endothermic Nucleating agent, Hydrocerol CF-20, available from Clariant for nucleating fine cells.

The above resin and additives were added into the feed hopper. Isobutane was mixed with the molten resin and additives and the melt was allowed to cool. The cooled mixture was extruded through an annular sheet die. The extrusion conditions and foam density are given in the following Table 1.

TABLE 1
Extrusion process formulation and conditions

| | | | | | | | Extruded |
|---|---|---|---|---|---|---|---|
| | | | | | | | Foam |
| | PP | LDPE | Rubber | Isobutane | Melt Temp. | Die Pressure, | Density, |
| Sample | (Lbs/hr) | (Lbs/hr) | (Lbs/hr) | (Lbs/hr) | (° F.) | (psi) | (pcf) |
| 1 | 160 (80%) | 40 (20%) | 0 | 3.92 | 329 | 410 | 4.35 |
| 2 | 160 (80%) | 38 (19%) | 2 (1%) | 3.92 | 329 | 410 | 4.2 |
| 3 | 160 (80%) | 34 (17%) | 6 (3%) | 3.92 | 329 | 380 | 4.2 |
| 4 | 160 (80%) | 30 (15%) | 10 (5%) | 3.92 | 329 | 400 | 4.5 |
| 5 | 160 (80%) | 20 (10%) | 20 (10%) | 3.92 | 329 | 395 | 5.0 |

Table 2 shows the tensile, tear, and elongation properties for the foam blends in Table 1. In these examples, flexibility was determined by placing the sample in a cold chamber at −20° F. for at least 24 hours. A high velocity piston struck the surface of the foam at a speed of 12 ft/sec. If the foam breaks or shatters, it is considered unacceptable. Samples where the foam traveled through the foam without breakage, were considered acceptable.

TABLE 2
Foam properties

| | | | | | | | | | Impact |
|---|---|---|---|---|---|---|---|---|---|
| | | | | | | | | | Cold |
| | | | | Tensile | Tensile | Tear | MD | cMD | Temp. Test |
| | PP | LDPE | rubber | MD | cMD | MD | Elongation | Elongation | −20° F. for |
| Sample | Weight % | Weight % | Weight % | (psi) | (psi) | (psi) | (%) | (%) | 24 hours |
| 1 | 80 | 20 | 0 | 213.5 | 148.7 | 27.3 | 4.9 | 1.1 | Broke |
| 2 | 80 | 19 | 1 | 208.2 | 142.1 | 29.8 | 7.5 | 2.0 | Broke |
| 3 | 80 | 17 | 3 | 191.5 | 152.5 | 34.8 | 6.8 | 3.6 | fractured |
| 4 | 80 | 15 | 5 | 199.0 | 157.6 | 41.3 | 11.6 | 5.4 | Did not |
| | | | | | | | | | break |
| 5 | 80 | 10 | 10 | 208.6 | 140.7 | 40.5 | 19.8 | 8.7 | Did not |
| | | | | | | | | | break |

Tensile and elongation properties were evaluated as per ASTM D412-98 test method. Tear strength was determined using ASTM D624-00 test method.

### Example 2

A twin-screw extruder was used to make PP/LDPE/rubber blend foam. The extrusion conditions are shown below in Table 3. The line output rate was held at 500 lbs./hr. The composition details are given in Table 3. For example, for sample 6, the percentages of polypropylene (PP), low density polyethylene (LDPE), styrene-isoprene styrene (SIS) rubber, ultraviolet inhibitor (UVI), and black colorant are 75.6%, 20%, 0%, 2.4%, and 2.0%, respectively. In addition to the mentioned additives, a talc masterbatch was added at 0.4% by weight to nucleate fine cells. The chemical ingredients used are listed below:
polypropylene homopolymer Model No. PF814 available from Basell Polyolefins
LDPE—2 MI, 0.919 g/cc LDPE available from Nova; and

styrene-isoprene-styrene rubber component Model No. Europrene Sol T 190 available from Enichem.

TABLE 3
Extrusion process formulation and conditions

| | | | SIS | | Black | | | | Die |
|---|---|---|---|---|---|---|---|---|---|
| | PP | LDPE | rubber | UVI | colorant | Output | Melt | Isobutane | Pressure |
| Sample | lb/hr | lb/hr | lb/hr | lb/hr | lb/hr | Rate (lb/hr) | Temp (° F.) | Rate (lb/hr) | (psi) |
| 6 | 378 | 100 | 0 | 12 | 10 | 500 | 310 | 38.0 | 490 |
| 7 | 378 | 85 | 15 | 12 | 10 | 500 | 309 | 38.0 | 490 |
| 8 | 378 | 75 | 25 | 12 | 10 | 500 | 308 | 38.2 | 470 |
| 9 | 378 | 50 | 50 | 12 | 10 | 500 | 312 | 38.4 | 420 |

The extruded foams were tested to evaluate their properties. The results are shown in Table 4. Sample 6 shows the data for the “Control” sample with no rubber content. For brittleness test, the foam samples were immersed in a cold bath at −4° F. for 5 hours and then the samples were bent and tested for breaking. Samples comprising less than 3% rubber broke. Samples having a rubber component greater than 3% showed the desired flexibility at −4° F. The resulting flexibility at sub-freezing temperatures is very useful for expansion joint filler or automotive tote applications.

TABLE 4
Foam Properties

| | Foam | Foam | MD* | cMD* | MD* | % Improvement | cMD* | 25% | Foam | |
|---|---|---|---|---|---|---|---|---|---|---|
| | Density | Thickness | Tensile | Tensile | Elongation | Over | Elongation | Comp. | Brittleness | Foam |
| Sample | (pcf) | (in) | (psi) | (psi) | at Break (%) | sample #6 | at Break (%) | (psi) | at −4° F. | Recovery % |
| 6 | 2.02 | 0.467 | 130.6 | 81.8 | 44.2 | — | 30.2 | 5.2 | yes | 98.1 |
| 7 | 2.12 | 0.445 | 115.9 | 77.6 | 50.8 | 14.93% | 41.0 | 5.4 | yes | 97.3 |
| 8 | 2.10 | 0.454 | 106.9 | 68.0 | 56.6 | 28.05% | 37.5 | 5.6 | no | 98.5 |
| 9 | 2.20 | 0.427 | 113.0 | 71.9 | 79.4 | 79.63% | 48.0 | 5.9 | no | 98.8 |

*MD and cMD represent machine direction and cross-machine directions, respectively.

The density was checked in accordance with ASTM D3575-00 test method. The compression and recovery were done in accordance with ASTM D545-99 test method. Tensile and elongation properties were evaluated as per ASTM D412-98 test method.

It is interesting to note that the percent elongation in the machine direction increases with the increase of rubber concentration in the formulation. For example, at 5% rubber concentration (sample 8), the percent elongation at break in the machine direction improved by 28%. Such improvements are desirable for the foam to remain flexible in filling the concrete expansion joint filler without tearing. Also, the 25% compression gradually improved with the addition of rubber component, which may indicate that the foam has a desired stiffness needed to serve for the expansion joint filler application.

### Example 3

A twin-screw extruder was used for this experiment. The foam was extruded in a cylindrical rod shape. Glycerol monostearate was used as an aging modifier to stabilize the foam and was added 1.6% by weight. Talc masterbatch was added 1.5% by weight to nucleate fine cells. The resin and additives were fed through the hopper and the molten polymer was mixed with the isobutane foaming agent. The mixture was then allowed to cool and pass through a capillary nozzle to result in a cylindrical rod shaped foam for evaluation and testing. The extrusion conditions are shown in Table 5 below. The ingredients used are given below.
PP—0.902 g/cc, polypropylene homopolymer
LDPE—2.3 MI, 0.919 g/cc LDPE
styrene-isoprene-styrene rubber component Model No. Europrene Sol T 190 available from Enichem; and

EVA—0.925 g/cc, 4.6 by wt % Ethylene/vinyl acetate copolymer

TABLE 5
Extrusion conditions and process formulation

| | | Output | Isobutane | Melt | | |
|---|---|---|---|---|---|---|
| | | rate, | rate | Temp. | Die Pressure | Torque, |
| Sample | Resin Blend Ratio | (lb./hr) | (lb/hr) | ° F. | (psi) | (Nm) |
| 10 | 80/20/0 PP/LDPE | 4.33 | 0.353 | 295 | 563 | 28.8 |
| 11 | 85/15/5 PP/LDPE/SIS | 4.50 | 0.353 | 290 | 600 | 27.4 |
| 12 | 85/15/5 PP/EVA/SIS | 4.29 | 0.353 | 288 | 534 | 26.4 |
| 13 | 60/35/5 PP/EVA/SIS | 3.84 | 0.353 | 281 | 613 | 30.0 |
| 14 | 50/45/5 PP/EVA/SIS | 3.88 | 0.353 | 272 | 706 | 32.4 |

The above foam samples were tested for density, cell count and percentage elongation at break to check their elasticity.

TABLE 6
Foam properties Data

| | | Foam | | Cell/ | % |
|---|---|---|---|---|---|
| | | Density | Cell/inch | inch | Elongation |
| Sample | Resin Blend Ratio | (pcf) | MD | cMD | at break |
| 10 | 80/20/0 PP/LDPE | 2.66 | 29 | 26 | 30.3 |
| 11 | 80/15/5 PP/LDPE/SIS | 2.20 | 39 | 29 | 51.2 |
| 12 | 80/15/5 PP/EVA/SIS | 2.48 | 39 | 29 | 58.2 |
| 13 | 60/35/5 PP/EVA/SIS | 3.03 | 38 | 29 | 84.0 |
| 14 | 50/45/5 PP/EVA/SIS | 3.11 | 32 | 26 | 86.7 |

The data in Table 6 indicates that percent elongation increases as the amount of EVA in the blend is increased. It is interesting to note that when 5% rubber was added the percent elongation improved from 30.3 to 51.2 (69% improvement). Replacing 4.6% of the LDPE with ethylene/vinyl acetate copolymer further improved the % elongation of the foam blend

### Example 4

A twin-screw extruder was to make the foam blends in example 4. The total resin (blend) rate was set at 718 lb/hr. Isobutane was added at 63 lb/hr. Glycerol monosterate was added as an aging modifier at 3.6 lbs/hr or 0.5%. Talc masterbatch was added at 4 lb/hr or 0.6%. UVI stabilizer and black color additives were added at 2% and 1.4% respectively. The extruded foam thickness ranged from 0.226 to 0.263 in thickness as shown in Table 7 below. The sheets were cured for a few days and then heat laminated close to ½″ approximately in thickness before the cold temperature test. The brittleness of the foam samples at cold temperature was evaluated by placing the sample in a 35° F. environment for 20 hours and then, the samples were bent up to a 90 degree angle. The flexibility of the foam is acceptable if the samples do not break when they are bent. The experimental data is summarized in Table 7.

The following materials were used: 2.3 MI, 0.918 density LDPE, EVA containing 9% vinyl acetate (VA) content, Rubber containing 84% SIS, polypropylene resins: (PP1 (PF814, high melt strength), PP2 (high melt strength, 0.902 g/cc), and PP3 (HL 783H low melt tension, 2.0 MI,0.902g/cc) available from Basell Polyolefins. Annular sheet die was used for foam extrusion.

TABLE 7
Extrusion conditions and Brittleness Test

| | | | | | thickness of | Brittleness at |
|---|---|---|---|---|---|---|
| | | Melt | Die | Finished | unlaminated | 35° F. for the |
| | | Temp. | Pressure | Foam Density | foam sheet | laminated |
| Sample | Composition & Ratio | ° F. | (psi) | (pcf) | (in.) | sample |
| A | 80/15/5 PP1/LDPE/Rubber | 315 | 380 | 2.00 | 0.234 | Passed |
| B | 80/15/5 PP2/LDPE/Rubber | 313 | 380 | 1.91 | 0.226 | Passed |
| C | 60/20/15/5 | 319 | 450 | 2.13 | 0.263 | Passed |
| | PP2/PP3/LDPE/Rubber | | | | | |
| D | 40/40/15/5 | 324 | 460 | 2.28 | 0.253 | Passed |
| | PP2/PP3/LDPE/Rubber | | | | | |
| E | 80/20 PP2/EVA | 316 | 470 | 1.83 | 0.247 | Passed |
| F | 60/20/20 PP1/PP3/LDPE | 319 | 450 | 1.95 | 0.245 | Failed |
| | (No Rubber) | | | | | |

Notably, the only sample that failed the flexibility test included no rubber component or EVA. As a result, it can be seen that the presence of the rubber component, EVA, or combination thereof may help improve the flexibility of the foam at cold temperatures. In addition, the presence of the rubber component also helps provide resiliency and long-term flexibility without undesirable degradation of properties. Sample E, comprising 80 weight percent polypropylene and 20 weight percent EVA was additionally tested for flexibility at sub-freezing temperatures. Sample E was place in a cold bath at 23° F. for 7 hours. Sample E was then removed from the bath and bent up to a 90 degree angle. The sample did not break or fracture.

### Example 5

In the following example, a foam blend comprising polypropylene and low density polyethylene (Sample G) was compared to two foam blends (Samples H and I) that were prepared in accordance of the invention. Sample H comprises a blend of polypropylene, EVA, and a rubber component. Sample I comprises a blend of polypropylene and EVA.

The foam blends were prepared in a similar fashion as described above. The following ingredients were used in the foam blends: 2.3 MI, 0.918 density LDPE, EVA having 4.6% vinyl acetate content, rubber component containing 84% SIS, polypropylene resin(PP1) (PF814, high melt strength) available from Basell Polyolefins; and polypropylene resin (PP3) (low melt tension, 2.0 MI, 0.902 g/cc) available from Basell Polyolefins.

TABLE 8
Foam Physical Properties

| | | | | | | | | 25% compression | MD | | Cell Count |
|---|---|---|---|---|---|---|---|---|---|---|---|
| | PP1 | PP3 | LDPE | EVA | rubber | Density | Recovery | strength | Elongation | Improvement | MD/cMD |
| Sample | Weight % | Weight % | Weight % | Weight % | Weight % | (psi) | (%) | (psi) | (%) | (%) | (#/inch) |
| G | 80 | — | 20 | — | — | 1.93 | 97.1 | 5.3 | 19.7 | — | 17/18 |
| H | 60 | 20 | — | 15 | 5 | 2.13 | 97.8 | 5.8 | 60.0 | +250.25 | 22/21 |
| I | 60 | 20 | — | 20 | — | 2.03 | 97.4 | 6.5 | 54.4 | +176.1 | 24/23 |

Tensile Elongational was determined with ASTM D412-98 test method. The percentage recovery and compression were determined with ASTM D545-99.

The data in Table 8 indicates that the addition of a rubber component helps improve the elongational properties of the foam bent. Improved elongation properties may help when the foam is stretched or bent during use. The data also indicates that the PP/EVA blend may be better suited in concrete joint filler applications than PP/LDPE foam blends. In addition, the data suggests that the rubber component may help improve the recovery of the foam after compression. It is also interesting to note that Samples H and I have better strength at 25% compression.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composition comprising a blend of
a) from about 1 to 45 percent by weight polyethylene;
b) at least about 50 percent by weight polypropylene; and
c) from about 3 to 10 percent by weight rubber component.

2. A composition according to claim 1, wherein said rubber component comprises a styrene-elastomer block copolymer having a tri-block copolymer structure that includes styrene end-blocks and a mid-block of a saturated olefin elastomer.

3. A composition according to claim 3, wherein said styrene-elastomer block copolymer is selected from the group consisting of styrene-butadiene-styrene, styrene-isoprene-styrene, styrene-ethylene-butylene-styrene, and styrene-ethylene-propylene-styrene.

4. A composition according to claim 1, wherein said polypropylene includes at least about 40 percent high melt tension polypropylene having a high melt tension of greater than about 20 centinewtons at 200° C., based on the total weight of polypropylene in the blend.

5. A composition according to claim 1, wherein said polyethylene is selected from the group consisting of low density polyethylene, ethylene vinylacetate, metallocene polyethylene, high density polyethylene, and combinations thereof.

6. A composition according to claim 1, wherein said polyethylene comprises a blend of low density polyethylene and ethylene vinylacetate.

7. A composition according to claim 1, wherein the amount of polypropylene in the blend is at least 70 percent by weight, based on the total weight of the blend.

8. A composition according to claim 1, wherein said foam is flexible at temperatures below 0° F.

9. A composition according to claim 1, wherein the blend comprises a foam.

10. A composition according to claim 1, comprising about 60 percent by weight high melt tension polypropylene having a high melt tension of greater than about 20 centinewtons at 200° C., about 20 percent by weight low melt tension polypropylene having a low melt tension of less than about 20 centinewtons at 200° C., about 15 percent by weight ethylene vinyl acetate, and about 5 percent by weight rubber component.

11. A flexible thermoplastic article having a foamed structure and comprising:
a) from about 1 to 45 percent by weight polyethylene;
b) at least about 50 percent by weight polypropylene; and
c) from about 3 to 10 percent by weight a styrene-elastomer block copolymer.

12. The article according to claim 11, wherein said styrene-elastomer block copolymer is a styrene-isoprene-styrene block copolymer.

13. The article according to claim 11, comprising about 15 percent by weight low density polyethylene, about 80 percent by weight polypropylene, and about 5 percent by weight styrene-elastomer block copolymer.

14. The article according to claim 11, comprising about 15 percent by weight ethylene vinyl acetate, about 80 percent by weight polypropylene, and about 5 percent by weight styrene-elastomer block copolymer.

15. A tote made from the foam of claim 11.

16. An expansion joint filler made from the foam of claim 11.

17. A method of making a foam, comprising:
a. forming a molten blend of polyethylene, polypropylene, and a rubber component, said rubber component being present in said blend at a weight percentage ranging from about 3 to about 10 percent, based on the weight of the blend;
b. adding a blowing agent to said blend; and
c. causing said blowing agent to expand within said blend, thereby forming a foam.

18. The method of claim 17, wherein said step of causing said blowing agent to expand is accomplished by extruding said blend and blowing agent through a die and into a region of reduced pressure.

19. The method of claim 17, wherein said foam is extruded as a foam sheet or plank having a thickness ranging from about 0.25 to about 4 inches.

20. The method of claim 17, wherein said foam has a density ranging from about 0.5 to about 15 pounds/ft³.

21. The method of claim 17, wherein said blowing agent comprises at least one physical blowing agent.

22. The method of claim 17, wherein said rubber component is selected from the group consisting of styrene-butadiene-styrene, styrene-isoprene-styrene, styrene-ethylene-butylene-styrene, and styrene-ethylene-propylene-styrene.

23. A foam blend comprising:
a. from about 5 to 25 percent by weight ethylene vinyl acetate; and
b. at least about 75 percent by weight polypropylene, and wherein said foam blend has improved flexibility at temperatures exceeding at temperatures below 32° F.

24. A foam blend according to claim 23, further comprising from about 3 to 10 weight percent rubber component, based on the total weight of the blend, said rubber component comprising a styrene-elastomer block copolymer selected from the group consisting of styrene-butadiene-styrene, styrene-isoprene-styrene, styrene-ethylene-butylene-styrene, and styrene-ethylene-propylene-styrene.

25. A foam blend according to claim 23, wherein the amount of ethylene vinyl acetate in the blend is from about 10 to 20 weight percent, based on the total weight of the blend.

26. A foam blend according to claim 23, wherein the % recovery of the foam blend exceeds the % recovery of a second foam blend comprising polypropylene and low density polyethylene, and wherein said second foam blend is characterized by the absence of ethylene vinyl acetate and a rubber component.
